(19) United States
(12) Patent Application Publication
(10) Pub. No.: US 2017/0131025 A1
(43) Pub. Date: May 11, 2017

(54) ELECTRIC HOUSEHOLD APPLIANCE WHICH CAN ALSO BE USED IN THE INDUSTRY FOR COOLING OR FREEZING AND HEATING WITH MAXIMUM SPEED

(71) Applicant: FRIGONDAS SOLUTIONS S.L., Madrid (ES)

(72) Inventors: Diego BENITO MAGRO, Madrid (ES); Jose Antonio MARTINEZ AROCA, Valencia (ES)

(21) Appl. No.: 15/318,204

(22) PCT Filed: Jun. 13, 2014
(86) PCT No.: PCT/ES2014/070489

§ 371 Date: Dec. 12, 2016

(51) Int. Cl. F25D 31/00; F25D 29/00; H05B 6/80; F25D 23/06

(52) U.S. Cl. CPC F25D 31/005; F25D 23/063; F25D 29/005; H05B 6/80; F25D 2201/10

(57) ABSTRACT

The invention relates to an electric household appliance for cooling or freezing and heating, which includes: a common mounting (17), an insulated compartment (18), elements necessary for cooling and heating, both arranged on the common mounting (17), and elements in common for both operating modes, wherein the compartment (18) consists of a series of side and top panels (15) made of an insulating material and capable of withstanding microwaves, and is arranged on an insulating panel (16) arranged between the compartment (18) and the common mounting (17), a rotary plate—perforated or in the form of a screen—is provided inside the compartment (18), and the compartment (18) has an inner gate (12) actuated by an electromagnet which is only actuated when the cooling operating mode is selected, said electromagnet being deactivated when the heating operating mode is selected, in order to allow ventilation. The features of the electric household appliance also ensure, in addition to cooling or freezing and heating, energy efficiency and uniformity in the cooling process.

### TECHNICAL FIELD

As indicated by the title, the object of the present invention is an electrical appliance that can also be used in the industry for cooling or freezing and heating with maximum speed, i.e., it is an electrical appliance which in a single piece of equipment functionally offers the possibility of being able to choose between cooling or freezing on one hand or being able to heat on the other.

The present invention is characterized by the special constructive features of the electrical appliance such that it allows offering both specified functionalities in a single apparatus, without impinging upon the performance of both functions.

Therefore, the present invention is comprised within the field of electrical appliances, and particularly in the field of those appliances for cooling as well as in the field of those appliances for heating products.

### PRIOR ART

Electrical appliances or equipment used for heating by means of microwaves, referred to as microwave ovens, used in kitchens for heating foods and operating by means of generating electromagnetic waves in the microwave frequency, around 2.45 GHz, are well-known in the state of the art.

An electrical appliance for cooling and freezing with maximum speed, such as that described in patent WO 2012098276, is also known in the state of the art.

The combination of both pieces of equipment in a single piece of equipment is not directly possible without overcoming a series of difficulties, such as the loss of energy efficiency as the equipment works for both functions, the use of additional means to achieve rapid cooling, providing means that allow uniform cooling without interfering in heating.

Therefore, an object of the present invention is to develop equipment that can be used for cooling or freezing and for heating, overcoming the aforementioned drawbacks of energy efficiency, cooling uniformity, developing an electrical appliance such as that described below and the essential features of which are included in claim 1.

### DISCLOSURE OF THE INVENTION

The object of the present invention is an electrical appliance for cooling or freezing and for heating rapidly, performing one function or the other according to what has been selected on a control panel.

To perform the cooling functions, the electrical appliance comprises:
a compressor unit that suctions the refrigerant gas at a low pressure and compresses it;
a condenser or radiator, where the refrigerant changes from a gas to a liquid, i.e., it condenses, a process in which heat dissipates out;
a first filter drier;
a capillary tube breaking down the particles, switching from a high pressure state to a low pressure state, changing to a liquid state;
an evaporator or radiator where the change from liquid to gas takes place, for which process heat must be added; said heat is absorbed from the products (foods) arranged inside the electrical appliance, causing such products to cool down;
turbines or generators which, connected with the inner compartment, facilitate the exchange of heat from foods and/or beverages into the refrigerant gas circulating through the evaporator by means of the air streams generated, therefore the foods give their heat off more quickly, said heat being absorbed by the refrigerant gas, achieving more rapid and uniform cooling;
a second filter placed specifically at the outlet of the evaporator and before the gas enters the compressor unit, accelerating the cooling process.

To carry out heating functions, the electrical appliance comprises:
a magnetron, which generates microwave frequency from electrical voltage
a cooling fan for the magnetron

To perform both functionalities, the equipment comprises as a whole:
an electronics board,
a control panel which allows, among other functionalities, selecting between one operating mode or the other in an exclusive manner,
insulating panels which can be made of polyamide or silica in a possible embodiment.

To allow correct operation from an energy point of view, and particularly during cooling, the electrical appliance as a whole has a compartment closed by a series of insulating panels.

Furthermore, the rotating plate is in the form of a grid or grille, i.e., it is slotted such that it allows the passage of the air stream generated by the fans associated with the cooling means in order to uniformly cool the product to be cooled. Since the plates currently used in microwaves are made of glass, they offer insulation against heat and cold.

The electromagnet operates an inner hatch (located in the right portion, close to the magnetron) that is closed when the electrical appliance is working in the cooling mode to offer a more effective closure and to prevent hot air from the outside from getting in; said electromagnet will no longer operate when the operating mode for heating is selected to favor the exit of gases resulting from heating beverages and foods.

Additionally and complementarily, the turbines or fans are protected by means of structures for capturing electromagnetic radiation.

Throughout the description and claims the word “comprises” and variants thereof do not seek to exclude other technical features, additives, components or steps. For the persons skilled in the art, other objects, advantages and features of the invention will be understood in part based on the description and in part based on the practice of the invention.

### DESCRIPTION OF THE DRAWINGS

To complement the description that is being made and for the purpose of aiding to better understand the features of the invention according to a preferred practical embodiment thereof, a set of drawings is attached as an integral part of said description, where the following is depicted with an illustrative and non-limiting character.

FIG. 1 shows a perspective view of the inside of the electrical appliance where the distribution of the different elements for being able to heat and cool can be seen.

FIG. 2 shows a view different from the preceding drawing, in which the different components can also be seen.

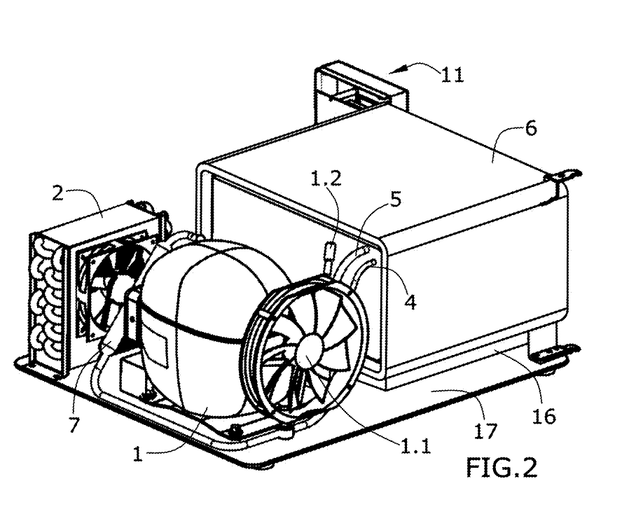

FIG. 3 shows the electrical appliance seen from the access opening.

### DETAILED DISCLOSURE OF THE INVENTION

A preferred embodiment of the proposed invention is described below in view of the drawings.

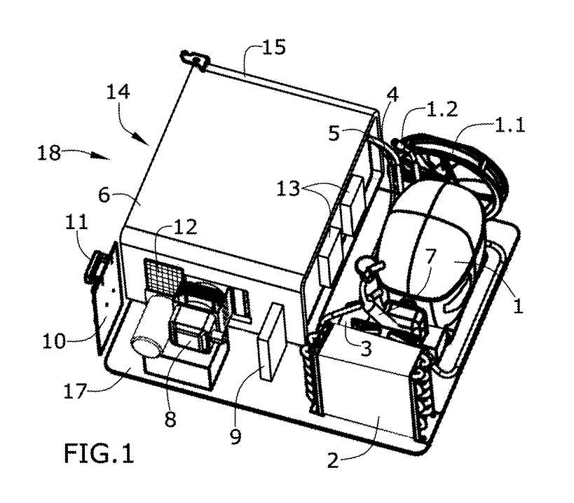

FIG. 1 shows a common support (17) on which there is arranged an insulated compartment (18) together with the elements necessary for cooling and heating, the entire assembly being suitably closed by panels to achieve a compact and closed assembly.

The insulated compartment (18) comprises an access opening (14) into the inside where the products or foods to be cooled and heated are arranged; it furthermore has a series of insulated side panels and an insulated upper panel and an insulating lower panel (16).

The side and upper panels are preferably, though not in a limiting manner, made from polyamide or silica and from materials resistant to the action of microwaves.

The elements necessary for cooling and heating are arranged on the common support (17) and next to the insulated compartment (18).

The elements necessary for cooling are:
a compressor unit (1) for compressing the gas at a higher pressure, discharging it into
a condenser (2) in which refrigerant changes from a gas state to a liquid state, which requires dissipating heat,
a first filter (3) placed at the outlet of the condenser (2),
a capillary tube (4) arranged between the first filter (3) and before the inlet (5) of the evaporator (6),
the evaporator (6) where the change from liquid to gas takes place, in which process heat must be added, and said heat is absorbed from the beverages and foods placed inside the compartment (18),
a second filter (7) placed specifically at the outlet of the evaporator (6) and before the inlet in the compressor unit (1).

An inner hatch (12) and second fans (13) are arranged to facilitate absorbing the heat from foods on the side walls of the compartment (18).

The elements necessary for carrying out on the compartment (18) a process for heating the beverages and foods placed therein are:
a magnetron (8) for converting electric current into high-frequency waves,
a fan (9) for the magnetron

The electrical appliance as a whole comprises:
an electronic control board (10) for controlling and operating the entire assembly,
a control panel arranged in the front portion where the access opening (14) into the compartment is arranged. This control panel allows exclusively selecting between the function of heating or the function of cooling, in addition to being able to select the operating mode and characteristics in the cooling and heating process, and the menu is then accessed to configure each manner of operating.

As previously indicated, it is necessary to arrange not only means for heating or cooling but rather a series of additional measures to improve overall operation, energy balance and uniformity in the cooling and heating process.

On one hand, the insulating panels (15) of the compartment (18) are made from a material capable of withstanding the action of microwaves, in addition to offering thermal insulation, polyamide or silica being a possible choice.

Furthermore, there is arranged on the inner hatch (12) operated by means of an electromagnet (not depicted) that operates only when the operating mode for cooling is selected. Therefore, a leak-tight closure of the hatch is thus obtained, preventing the entrance of heat from outside, said electromagnet being deactivated when the operating mode for heating is selected, such that the inner hatch (12) allows the exit of gases and vapors released by foods.

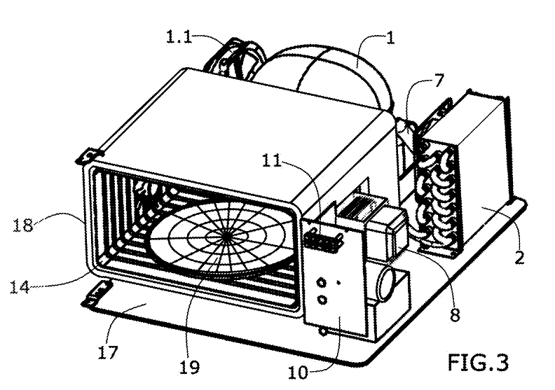

Also, and for the purpose of achieving a more uniform process, especially in relation to cooling, inside the compartment (18) there is arranged a rotating plate (19) in the form of a grille (FIG. 3) or a slotted plate for the purpose of allowing the air stream from the fans (18) to flow therethrough and thus allowing heat transfer from the foods and beverages and achieving a more uniform cooling.

FIG. 3, which complements the preceding figures, shows the insulated compartment (18) inside which heating or cooling takes place, according to whether one operating mode or the other is selected, accessing the inside of the insulated compartment (18) through an access opening (14) on which a door for opening and closing, which is not depicted, would be assembled. inside the insulated compartment, there is a plate (19) in the form of a grille or a slotted plate which facilitates the process of making the cooling and heating process more uniform.

Said FIG. 3 also shows the control panel (11) assembled on the electronics board (10).

Having sufficiently described the nature of the present invention as well as the manner of putting it into practice, it is hereby stated that, within its essential nature, the invention can be carried out into practice in other embodiments differing in detail from the embodiment indicated by way of example, and such embodiments would also be covered by the protection that is sought provided that the fundamental principle thereof is neither altered, changed nor modified.

1-6. (canceled)

7. An electrical appliance for cooling or freezing and heating comprising:
a common support an insulated compartment arranged on the common support elements necessary for cooling and heating, also arranged on the common support, the entire assembly being closed by panels, elements common to both operating modes wherein the compartment is formed by a series of side and upper panels made from an insulating material capable of withstanding microwaves, and it is arranged on an insulating panel placed between the compartment and the common support, there is arranged inside the compartment a rotating plate in the form of a grille or a slotted plate, the compartment has an inner hatch operated by means of an electromagnet that operates only when the operating mode for cooling is selected, preventing the entrance of heat from outside said electromagnet being deactivated when the operating mode for heating is selected such that the inner hatch allows the exit of gases and vapors released by foods.

8. The electrical appliance for cooling or freezing and heating according to claim 7, wherein the insulating material used in the walls of the compartment is polyamide or silica.

9. The electrical appliance for cooling or freezing and heating according to claim 7, wherein the elements necessary for cooling and heating comprise:
a compressor unit for compressing the gas at a higher pressure, discharging it into a condenser in which refrigerant goes from a gas state to a liquid state, which requires dissipating heat, a first filter placed at the outlet of the condenser , a capillary tube arranged between the first filter and before the inlet of the evaporator, the evaporator where the liquid to gas conversion takes place, in which process heat must be added, and said heat is absorbed from the beverages and foods placed inside the compartment, a second filter placed at the outlet of the evaporator and before the inlet in the compressor unit.

10. The electrical appliance for cooling or freezing and heating according to claim 8, wherein to facilitate absorbing heat from foods on the side walls of the compartment there is arranged an inner ventilation hatch that opens or closes according to the operating mode, and second fans.

11. The electrical appliance for cooling or freezing and heating according to claim 7, wherein the elements necessary for carrying out on compartment a process for heating the beverages and foods placed therein are:
a magnetron for converting electric current into high-frequency waves, a fan for the magnetron.

12. The electrical appliance for cooling or freezing and heating according to claim 7, wherein the elements common to both operating modes are:
an electronic control board for controlling and operating the entire assembly,
a control panel arranged in the front portion where the access opening into the compartment is arranged; said control panel allows exclusively selecting between the function of heating or the function of cooling, in addition to being able to select the operating mode and
characteristics in the cooling and heating process, and the menu is then accessed to configure each manner of operating.
